(19) United States
(12) Patent Application Publication
(10) Pub. No.: US 2003/0198839 A1
(43) Pub. Date: Oct. 23, 2003

(54) Method for operating an HT-PEM fuel cell system, and associated fuel cell system

(76) Inventors: Rolf Bruck, Bergisch Gladbach (DE); Joachim Grosse, Erlangen (DE); Manfred Poppinger, Uttenreuth (DE); Meike Reizig, Bonn (DE)

Correspondence Address: LERNER AND GREENBERG, P.A., Post Office Box 2480, Hollywood, FL, 33022-2480, US

(21) Appl. No.: 10/426,522

(22) Filed: Apr. 30, 2003

Related U.S. Application Data
(63) Continuation of application No. PCT/DE01/04114, filed on Oct. 31, 2001.

(30) Foreign Application Priority Data
Oct. 31, 2000 (DE) 100 54 050.3

(51) Int. Cl. H01M 8/24; H01M 8/10

(52) U.S. Cl. 429/13; 429/32

(57) ABSTRACT

An HT-PEM fuel cell installation is cascaded and the fuel cells are driven in cascade operation. This enables the outlet emissions to be influenced advantageously and undesirable emissions can be reduced to a minimum.

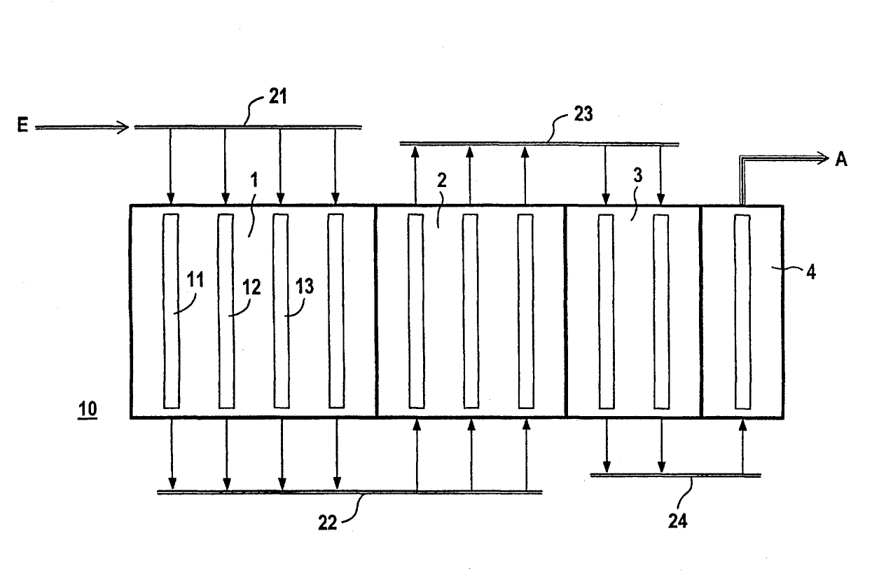

### CROSS-REFERENCE TO RELATED APPLICATION

This application is a continuation of copending International Application No. PCT/DE01/04114, filed Oct. 31, 2001, which designated the United States and which was not published in English.

### BACKGROUND OF THE INVENTION

Field of the Invention

The invention lies in the high-temperature fuel cell technology field. More specifically, the invention relates to a method for operating an HT-PEM fuel cell system. The system comprises at least one fuel cell module, in the form of a stack of fuel cells, for hydrogen operation. In addition, the invention also relates to an associated HT-PEM fuel cell system having at least one fuel cell module for hydrogen operation.

PEM fuel cells are known from the prior art (PEM, polymer electrolyte membrane, proton exchange membrane). The term HT-PEM fuel cell system (HT, high temperature) is to be understood as meaning a system in which the fuel cells are polymer electrolyte membrane fuel cells which work at elevated operating temperatures. In the present context, elevated operating temperatures are to be understood as meaning higher temperatures than the working temperature of the PEM fuel cell of 60° C., specifically temperatures of between 60° C. and 300° C., in particular in the range between 120° and 200° C.

Furthermore, it is known from the prior art, in the case of fuel cell systems which are specifically designed for submarine operation, for the fuel cells which have been combined to form a stack to be operated in cascaded form. This is intended to achieve optimum utilization of the fuel. U.S. Pat. No. 5,478,662 and European patent EP 0 596 366 B1 describe a method and an associated device in which the fuel cell is concentrated by a suitable fluid system after it has flowed in parallel through a first group of fuel cells and is then successively fed to further fuel cell groups.

It is not possible to transfer that configuration to an HT-PEM fuel cell system. Nevertheless, the technology is subject to the same demands in practice.

### SUMMARY OF THE INVENTION

It is accordingly an object of the invention to provide a method of operating an HT-PEM fuel cell installation, which overcomes the above-mentioned disadvantages of the heretofore-known devices and methods of this general type and which further improves the operation of an HT-PEM fuel cell system.

With the foregoing and other objects in view there is provided, in accordance with the invention, a method of operating an HT-PEM fuel cell system having at least one fuel cell module with a stack of HT-PEM fuel cells for hydrogen operation. The method comprises operating the fuel cell module with the HT-PEM fuel cell in cascaded operation.

In other words, the invention proposed measures and associated means for constructing a fuel cell module which enables an HT-PEM fuel cell system to operate in cascaded mode. The HT-PEM fuel cell system is operated in the temperature range between 60° C. and 300° C., preferably between 120° C. and 180° C.

The invention advantageously enables the so-called λ value to be set at a targeted level during fuel operation. This specifically results in particular advantages for the HT-PEM fuel cell.

In accordance with an added feature of the invention, therefore, the method comprises setting the cascaded operation to influence an exhaust emission from the fuel cell module and, specifically, to reduce undesirable exhaust emission from the fuel cell module.

With the above and other objects in view there is also provided, in accordance with the invention, an HT-PEM fuel cell system having at least one fuel cell module with HT-PEM fuel cells for hydrogen operation which is improved with means for defining a cascaded structure of the fuel cell module.

In accordance with an additional feature of the invention, the fuel cell module is divided into a plurality of individual units defining the cascaded structure of the fuel cell module.

In accordance with another feature of the invention, the HT-PEM fuel cell system is provided with a common fuel gas system supplying individual units of said fuel cell module with fuel gas. The division of the system is attained with several inlet headers that distribute the fuel feed in cascaded form.

In accordance with a concomitant feature of the invention, the novel method comprises providing the above-summarized HT-PEM fuel cell system and operating the same in cascaded operation.

Other features which are considered as characteristic for the invention are set forth in the appended claims.

Although the invention is illustrated and described herein as embodied in a method for operating an HT-PEM fuel cell system, and associated fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWINGS

The sole FIGURE is a diagram of a fuel module of an HT-PEM fuel cell system with means for cascaded operation.

### DESCRIPTION OF THE PREFERRED EMBODIMENTS

Referring now to the sole FIGURE of the drawing in detail, there is shown a fuel cell module 10 comprising a multiplicity of fuel cell units. The fuel cell module is part of an HT-PEM fuel cell system. As with the standard PEM fuel cell, the stacking of the fuel cell units with in each case one membrane electrode assembly (MEA) results in what is known in the specialist terminology as a stack. An HT-PEM fuel cell stack of this type is operated at higher temperatures than the conventional PEM fuel cell, which operates, for example, at 60° C. By way of example, an HT-PEM fuel cell stack of this type is operated at temperatures of between 60 and 300° C. Advantageous operating temperatures for the HT-PEM fuel cell are between 120° C. and 200° C.

The fuel cell module 10 is divided into individual units 1, 2, 3, 4, . . . , the FIGURE illustrating, by way of example, a cascade having four units 1 to 4. All four units 1 to 4, which have a successively decreasing number of fuel cell units and MEAs, are operated in cascaded form with hydrogen as fuel gas from a common fuel gas system, allowing suitable adjustment of the fuel gas. The cascaded operation results in an improvement to the process management such that in each case the appropriate quantity and concentration of hydrogen is present at the sensitive MEAs of the HT-PEM fuel cells.

The fuel cell module 10 is supplied with the fuel gas via an inlet E. The fluid lines in the individual cascade stages are denoted by 21 to 24, which may be also referred to as headers 21-24. Residual gas is discharged at an outlet A.

The cascaded arrangement described makes it possible even for HT-PEM fuel cells to optimize the so-called X value, which is characterized by the use of the fuel gas. This results in considerable improvement specifically for HT-PEM fuel cells. In detail, the exhaust emissions can be influenced and therefore in particular polluting emissions to the environment can be reduced.

We claim:

1. In an HT-PEM fuel cell system having at least one fuel cell module with a stack of HT-PEM fuel cells for hydrogen operation, a method for operating the HT-PEM fuel cell system, which comprises operating the fuel cell module with the HT-PEM fuel cell in cascaded operation.

2. The method according to claim 1, which comprises operating the fuel cell module of the HT-PEM fuel cell system in a temperature range between 60° C. and 300° C.

3. The method according to claim 1, which comprises operating the fuel cell module of the HT-PEM fuel cell system in a temperature range between 120° C. and 200° C.

4. The method according to claim 1, which comprises setting the cascaded operation to influence an exhaust emission from the fuel cell module.

5. The method according to claim 1, which comprises adapting a cascaded arrangement for the cascaded operation to reduce undesirable exhaust emission from the fuel cell module.

6. In an HT-PEM fuel cell system having at least one fuel cell module with HT-PEM fuel cells for hydrogen operation, the improvement which comprises means for defining a cascaded structure of the fuel cell module.

7. The HT-PEM fuel cell system according to claim 6, wherein said fuel cell module is divided into a plurality of individual units defining the cascaded structure of the fuel cell module.

8. The HT-PEM fuel cell system according to claim 6, which comprises a common fuel gas system supplying individual units of said fuel cell module with fuel gas.

9. The HT-PEM fuel cell system according to claim 6, wherein said means include a plurality of inlet headers to said fuel cells.

10. The method according to claim 1, which comprises operating the HT-PEM fuel cell system according to claim 6 in cascaded operation.
